(19) United States
(12) Patent Application Publication
(10) Pub. No.: US 2026/0245817 A1
(43) Pub. Date: Aug. 20, 2026

(54) ELECTRIC ARC BLAST NOZZEL

(71) Applicant: GE Vernova Infrastructure Technology LLC, Greenville, SC (US)

(72) Inventors: Thibaud GRILLET, Villeurbanne (FR); Maxime TENET, Villeurbanne (FR); David BERARD, Villeurbanne (FR)

(21) Appl. No.: 19/531,891

(22) Filed: Feb. 6, 2026

(30) Foreign Application Priority Data
Feb. 17, 2025 (EP) 25158295.3

(51) Int. Cl. H01H 33/70

(52) U.S. Cl. CPC H01H 33/7023

(57) ABSTRACT

The invention refers to an electric arc blast nozzle having an interior housing extending along a longitudinal axis and enclosing an interior space. The interior housing is particularly configured to locate electrical contacts of a circuit breaker therein. When used in a circuit breaker, the electric arc blast nozzle can be moved together with one of the electrical contacts in longitudinal direction relative to the other electrical contact. According to the invention, the interior housing of the electric arc blast nozzle is intimately covered by at least one outer layer (32) comprising a reinforcement layer. In doing so, gas-filled gaps and cavities are avoided between the at least one outer layer and the interior housing, which reduces the risk of partial discharge.

### TECHNICAL FIELD

The invention refers to an electric arc blast nozzle that is particularly configured to be used in a high voltage circuit breaker. Such a high voltage circuit breaker can be used to interrupt an electrical connection in an electrical line, whereby an electrical voltage in a range of approximately more than 50 kV and up to 800 kV are applied between the contacts of the circuit breaker.

### BACKGROUND

Circuit breakers are known in many different configurations. For example, KR 1020190110842 A discloses an ultra-high voltage circuit breaker having a fixed arc contact and a movable arc contact. It compresses a main nozzle coupled to the distal end of a cylinder provided for moving the movable arc contact. A nozzle support member is partly inserted into a cut out of the main nozzle to improve the mechanical strength.

JP 2021051945 A relates to a gas circuit breaker having a cylinder arranged in a container that is filled with an insulating gas. When a movable contact is moved in axial direction toward a stationary contact, insulating gas is ejected to blow out an arc generated between the movable and the stationary contact. One end of the cylinder housing is connected with a nozzle part that surrounds the movable contact at least partly.

A gas-blast circuit breaker is known from JP 2018 116852 A. A nozzle part surrounds a movable electrical contact at least partly. Material having high mechanical strength is placed on the nozzle part so that it does not directly contact an insulating gas flowing through the nozzle part in order to blow out an electrical arc.

A circuit breaker with a nozzle is disclosed in WO 95/33274 A1. A plastic tube surrounds the nozzle partly and is provided to avoid radial widening of the nozzle. The plastic tube can be made of fiber reinforced composite plastic.

EP 3 479 390 A1 shows an electric arc blast nozzle that consists of multiple parts arranged next to one another in a longitudinal direction: two end parts and a median neck-forming part arranged between the two end parts. In order to fixate these three parts, the housing can be surrounded by a sheath made of a dielectric material, such as polytetrafluoroethylene.

### SUMMARY

When assembling an electric arc blast nozzle from multiple parts in homogeneous, electrical field strengths may result that can in turn lead to a partial discharge. It can be considered as object of the present invention to provide an electric arc blast nozzle that avoids or at least reduces the risk of partial discharge.

This object is solved by means of an electric arc blast nozzle having the features of claim 1.

The electric arc blast nozzle according to the invention is configured to be used in a high voltage circuit breaker. For example, the high voltage circuit breaker can be configured to electrically insulate voltages between its two electrical contacts in a range of 52 kV and 800 kV.

The electric arc blast nozzle comprises an interior housing extending along a longitudinal axis. The direction parallel to the longitudinal axis is denoted as longitudinal direction. The interior housing comprises first and second nozzle end sections and an intermediate nozzle section arranged therebetween. The interior housing surrounds an inner space through which an insulating gas may flow in order to blow out an electrical arc. The insulating gas may be any appropriate gas used or known for this purpose, such as sulphur hexafluoride (SF₆), carbon dioxide (CO₂), nitrogen (N₂), a mixture of one of the afore-mentioned gases comprising optionally at least one of the following components: dioxygen (O₂) and fluornitrile (for example C4-PFN) and fluorketone (for example C5-PFK).

The interior housing may contain a dielectric material or a combination of two or more dielectric materials. It may contain or consist of at least one of polytetrafluorethylene (PTFE), a polymer, glass or porcelain. For example, glass can be particularly used as filler in combination with another material.

The electric arc blast nozzle, according to the invention, comprises at least one outer layer. The outer layer, or at least one of the outer layers, is directly applied on the outer surface of the interior housing and can be denoted as innermost layer. The outer layer, or at least one of the outer layers, is a reinforcement layer. The reinforcement layer may contain or consist of at least one of the following materials: a synthetic resin, preferably an epoxy resin, a modified epoxy resin comprising at least one viscosity-lowering reactive diluent, a polymer material or a ceramic material. Any epoxy resin may be fluorinated or may not contain any fluorine. Optionally, reinforcement fibers may be embedded in a matrix containing one of the indicated materials.

The material of the reinforcement layer has preferably a lower density compared to the material of the interior housing. For example, if a synthetic resin, such as epoxy resin, is used for the reinforcement layer, the density is less than 50% compared to the density of an interior housing made of polytetrafluorethylene (PTFE).

The configuration, according to the invention, has therefore also the advantage to reduce weight of the electric arc blast nozzle. The electric arc blast nozzle provides high mechanical strength. Moreover, the environmental impact of the electric arc blast nozzle according to the invention is less than in electric arc blast nozzles according to the prior arc. The use of environmental critical materials, such as polytetrafluorethylene, may be reduced and replaced by materials that are less critical or detrimental for the environment, for example reduces per- and polyfluoroalkyl substances (PFAS) used in the electric arc blast nozzle.

The housing outer surface e of the interior housing may be subject to a surface treatment prior to applying the outer layer or one of the outer layers. Such a surface treatment may comprise chemical and/or electro-chemical and/or thermal and/or physical surface treatment processes, such as at least one of: cleaning, pickling, etching, creation of conversion layers, shot peening or sandblasting. This treatment may prepare the outer surface of the interior housing for the subsequent application of the outer layer or the innermost layer of the outer layers. For example, if the interior housing contains fluorine (e.g. polytetrafluoroethylene), an etching process may eliminate fluorine at least on the housing outer surface and potentially in a certain depth from the housing outer surface. This improves continuous two-dimensional intimate contact between the adjoining (innermost) outer layer and the housing outer surface of the interior housing.

The outer layer that directly adjoins the housing outer surface of the interior housing is applied onto the housing outer surface of the interior housing in close two-dimensional contact. Particularly, in the contact area between the housing outer surface and the adjoining outer layer no gas including gaps or cavities are present, which could influence an electric field resulting in partial discharge (PD). If any gas including gap or cavity is present, it has a small volume and dimension that is unable to influence the electric field in a manner resulting in partial discharge (PD) at this position.

Thus, in accordance with the present invention, an intimate connection between the housing outer surface and the directly adjoining (innermost) outer layer is provided. For example, this can be realized by forming the at least one outer layer onto the housing outer surface using an overmolding method or any other known suitable method.

The number of outer layers may vary. At least one reinforcement layer and particularly only one reinforcement layer is provided. As an option in addition to the at least one reinforcement layer, one or more additional outer layers may be provided, such as one or more insulation layers for increasing the dielectric strength of the electric arc blast nozzle. The at least one insulation layer may comprise at least one of the following materials: polypropylene (PP), polystyrol (PS), polyvinylchloride (PVC), any other polymer material, glass or porcelain.

Preferably the at least one outer layer, and particularly the outer layer adjoining the housing outer surface is attached to the latter by means of a substance bond.

For example, the at least one outer layer may be attached to the housing outer surface during its production, for example by means of multi-component molding, such as multi-component injection molding. For example, the interior housing may be placed inside a mold and subsequently the at least one outer layer may be produced.

If more than one outer layer is provided, first the outer layer directly adjoining the housing outer surface can be produced (for example molded) and subsequently, in the desired order, one or more additional outer layers can be produced (for example molded).

The reinforcement layer and/or any other optional outer layer may extend in longitudinal direction at least over the first nozzle end section, but leaving at least parts of the intermediate nozzle section and the second nozzle end section uncovered. Optionally, the at least one outer layer and particularly the reinforcement layer may cover the first nozzle end section completely and may extend in longitudinal direction partly or entirely over the intermediate nozzle section, but leaving at least parts of the second nozzle end section and optionally the intermediate nozzle section and uncovered. In another optional embodiment, the at least one outer layer and particularly the reinforcement layer may completely cover the first nozzle end section, the intermediate nozzle section and may extend in longitudinal direction at least partly or entirely over the second nozzle end section. In one embodiment, the at least one outer layer and particularly the reinforcement layer covers the housing outer surface of the interior housing entirely in longitudinal direction from one end to the other end.

In all of the embodiments the at least one outer layer may extend continuously in circumferential direction around the longitudinal axis (e.g. in ring- or sleeve-shaped manner), preferably without any interruption (such as holes, cavities, slots, etc.).

Due to providing a reinforcement layer at least partly around the interior housing, the wall thickness of the interior housing may be reduced at least in the areas where the reinforcement layer is present. The wall thickness may be reduced at least about approximately 5% or 10% or 15% compared to an embodiment where the interior housing is not provided with a reinforcement layer on the outside. Due to the intimate contact between the adjoining outer layer and the housing outer surface and—if applicable—between two adjoining outer layers, no gas (particularly air) filled gaps or cavities are present that could considerably disturb or influence an electric field. Thereby the risk of partial discharge is reduced and at least largely eliminated.

### BRIEF DESCRIPTION OF THE DRAWINGS

Preferred embodiments of the present invention are disclosed in the dependent claims, the description and the drawing. In the following, preferred embodiments of the invention are explained in more detail with reference to the attached drawing. The drawing shows:

FIGS. 1 to 4 an embodiment of an electric arc blast nozzle having an interior housing and at least one outer layer provided on an housing outer surface of the interior housing in each case,

FIG. 5 a schematic illustration of two parts assembled to one another according to the prior art,

FIG. 6 a schematic illustration of a portion of the interior housing and the housing outer surface provided with an adjoining outer layer in tight continuous two-dimensional contact and

FIG. 7 a schematic basic illustration of a high voltage circuit breaker comprising an electric arc blast nozzle according to the invention.

### DETAILED DESCRIPTION

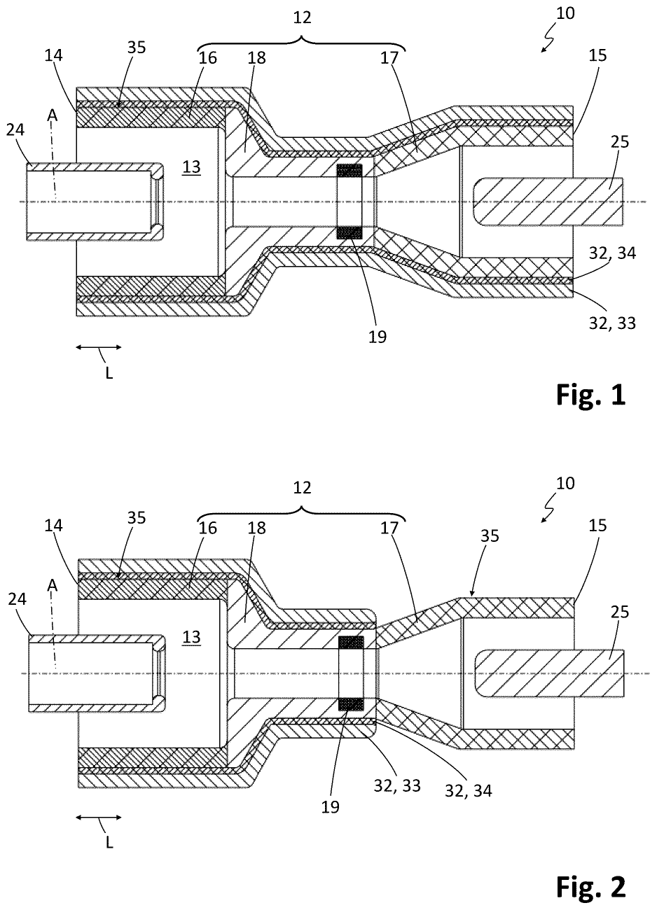

In FIGS. 1 to 4 different embodiments of an electric arc blast nozzle 10 that can be used in a high voltage circuit breaker 11, as illustrated highly schematically in FIG. 7.

The electric arc blast nozzle 10 comprises an interior housing 12 that extends along a longitudinal axis X. A direction parallel to the longitudinal axis X is denoted as longitudinal direction L.

The interior housing 12 surrounds a volume or inner space 13 that continuously extends through the interior housing 12 from a first axial end 14 to a second axial end 15 of the interior housing 12 with view in longitudinal direction L. In circumferential direction around the longitudinal axis X the interior housing 12 encloses the inner space 13 entirely.

As apparent from FIGS. 1 to 4, the interior housing 12 comprises multiple parts or sections adjoining one another in longitudinal direction L. These parts or sections may comprise at least two individual parts connected to one another or may be realized as monolithic housing body.

The interior housing 12 has a first nozzle end section 16 comprising the first axial end 14 and a second nozzle end section 17 comprising the second axial end 15 of interior housing 12. With view in longitudinal direction L, an intermediate nozzle section 18 is arranged between the two nozzle end sections 16, 17 and connects first nozzle end section 16 with second nozzle end section 17.

The interior space 13 has a reduced cross-section area or diameter inside the intermediate nozzle section 18 compared to the adjoining first and second nozzle end sections 16, 17. Therefore the intermediate nozzle section forms a neck section inside the interior housing 12.

Optionally, an insert 19, particularly a ring- or sleeve-shaped insert, may be arranged in the intermediate nozzle section 18, directly adjoining the inner space 13. The insert 19 can be made of a material having a higher dielectric strength compared to the material of the intermediate nozzle section 18. The insert may contain at least one of a fluorcarbon polymer material, such as polytetrafluorethylene (PTFE), a ceramic material, sulphur, graphite, mica, glass and fluoride.

This insert 19 is an optional feature and can be provided or omitted in any embodiment of the electric arc blast nozzle 10, as depicted in FIGS. 1 to 3.

In the first nozzle end section 16 and/or the second nozzle end section 17, the cross-section area of the inner space 13, may increase continuously and/or in a stepwise manner in longitudinal direction L and away from the intermediate nozzle section 18 respectively (i.e. away from the intermediate nozzle section 18 toward the first axial end 14 or the second axial end 15 respectively). As exemplarily illustrated, the cross-section area of the inner space 13 can be constant along the first nozzle end section 16, whereby a step of the inner space 13 is created at the transition location between the first nozzle end section 16 and the intermediate nozzle section 18. In the embodiment this step is provided by a face of the intermediate nozzle section 18. As also exemplarily shown in FIGS. 1 to 4, starting from the intermediate nozzle section 18, the cross-section area of the inner space 13 can increase continuously along a tapering section of the second nozzle end section 17 and may have a constant cross-section area between the tapering section and the second axial end 15.

The specific dimension and shape of the interior housing 12 and particularly the first nozzle end section 16, the second nozzle end section 17, and the intermediate nozzle section 18 may vary and may also be modified compared to the illustrations in FIGS. 1 to 4.

The first nozzle end section 16 and/or the second nozzle end section 17 and/or the intermediate nozzle section 18 may consist of different materials. For example, the first nozzle end section 16 may comprise a fluorcarbon polymer matrix, such as a polytetrafluorethylene matrix, that can be combined with a certain amount of inorganic material. For the intermediate nozzle section 18 and/or the second nozzle end section 17 other materials can be used compared to the material of the first nozzle end section 16, such as polypropylene (PP), polystyrol (PS), polyvinylchloride (PVC), any other polymer material, glass or porcelain.

In the embodiment schematically illustrated in FIG. 4, the interior housing 12 can be a monolithic body, wherein first nozzle end section 16, second nozzle end section 17 and intermediate nozzle section 18 consist of the same material and forming sections of one monolithic interior housing body.

As particularly apparent from FIGS. 1 to 4 and FIG. 7, the two nozzle end sections 16, 17 are configured to receive electrical contacts. Specifically, a first electrical contact 24 may project into the inner space 13 inside first nozzle end sections 16 and a second electrical contact 25 may project into the inner space 13 inside second nozzle end sections 17. In the embodiment the first electrical contact 24 is configured as movable contact that can be displaced in longitudinal direction L together with the electric arc blast nozzle 10 toward and away from the second electrical contact 25. In the illustrated embodiments, the first electrical contact 24 is a female contact and the second electrical contact 25 is a male contact.

The operation of the circuit breaker 11 is apparent from the schematic basic illustration in FIG. 7. When the two electrical contacts 24, 25 approach one another or are separated from one another, an electrical arc EA is created when the two electrical contacts 24, 25 are arranged distant from one another, while the distance between the two electrical contacts 24, 25 is insufficient to electrically insulate the two electrical contacts 24, 25 from one another by means of the surrounding gas atmosphere. Electrical arc formation is undesired, because the electrical arc EA maintains the electrical connection between the two electrical contacts 24, 25, even when such an electrical connection is not yet or no longer desired. To support extinguishing the electrical arc EA, the circuit breaker 11 comprises a gas flow producing device 26. For example, the gas flow producing device 26 may comprise at least one piston 27 that is movably arranged inside a cylinder chamber 28 adjacent to or surrounding the first electrical contact 24.

By means of the gas flow producing device 26 a gas flow G inside and along the inner space 13 can be created in order to blow out an electrical arc EA created between the two electrical contacts 24, 25. In the illustrated embodiment the gas flow G may flow from the gas flow producing device 26 around the first electrical contact 24 inside the inner space 13, further downstream into the intermediate nozzle section 18, and thereby in the area between the two electrical contacts 24, 25 for blowing out the created electrical arc EA. The gas may flow out of the intermediate nozzle section 18 downstream into the second nozzle end section 17 and out of the interior nozzle housing 12.

The gas flow G illustrated in FIG. 7 and explained above occurs, for example, if the two electrical contacts 24, 25 move away from each other. On the other hand, a flow direction of the gas flow G may be in opposite direction if the two electrical contacts 24, 25 approach one another.

According to the invention, at least one outer layer 32, is provided on the interior housing 12. The at least one outer layer 32 comprises at least a reinforcement layer 33. Optionally, one or more additional outer layers 32 may be provided, such as an insulation layer 34, for increasing the dielectric strength. However, one reinforcement layer 33 is sufficient and additional outer layers 32 may be omitted in any embodiment of the electric arc blast nozzle 10.

In longitudinal direction L the at least one outer layer 32 and particularly the reinforcement layer 33 may extend over the entire length of the interior housing 12, that is from the first axial end 14 up to the second axial end 15 (FIGS. 1 and 4).

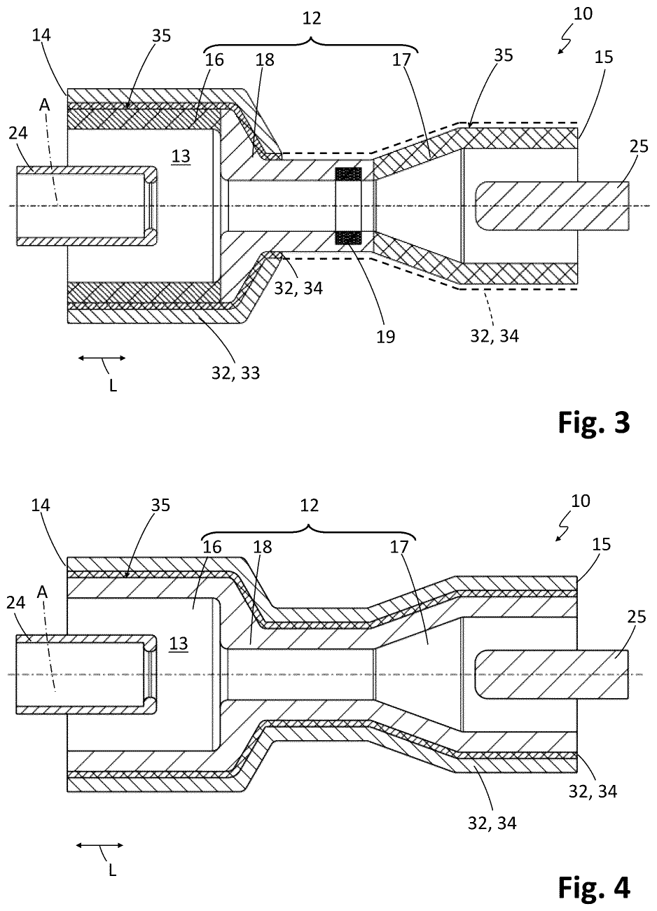

In modified embodiments the at least one outer layer 32 and particularly the reinforcement layer 33 may be shorter in longitudinal direction L than the interior housing 12. Embodiments for such a configuration are illustrated exemplarily in FIGS. 2 and 3. There, the at least one outer layer 32 extends in longitudinal direction L, at least over the first nozzle end section 16 and partly (FIG. 3) or entirely over the intermediate nozzle section 18. The second nozzle end section 17 may remain uncovered, as apparent from FIGS. 2 and 3.

In modification to the embodiments according to FIGS. 2 and 3, it would also be possible that one of the outer layers 32 (for example, the insulating layer 34) has a larger extension in longitudinal direction L than at least one other outer layer 32 (for example, the reinforcement layer 33). Such an embodiment is exemplarily and schematically illustrated in FIG. 3, where the longer extension of the insulating layer 34 is indicated by a dashed line. In this example, the insulating layer 34 extends over the entire interior housing 12 from the first axial end 14, up to the second axial end 15, whereas the reinforcement layer 33 is shorter in longitudinal direction L and extends from the first axial end 14 at least over the first axial end section 16, and partly—or as a further alternative entirely—over the intermediate nozzle section 18.

Apart from the extension of the at least one outer layer 32 in longitudinal direction L, the embodiments according to FIGS. 2 and 3 correspond to the embodiment according to FIG. 1, so that the detailed explanation of the electric arc blast nozzle 10 and the circuit breaker 11 applies similarly.

In the embodiment according to FIG. 4 the insert 19 is omitted. Omitting the insert 19 can be realized in any embodiment of the electric arc blast nozzle, particularly in the embodiments according to FIGS. 1 to 3.

In the embodiment of the arc blast nozzle 10 the interior housing 12 can be realized as monolithic body as explained above, which can also be realized in any embodiment of the electric arc blast nozzle 10, particularly in one of the embodiments according to FIGS. 1 to 3.

In modification to the illustrations according to FIGS. 1 to 4, the number of outer layers must not necessarily be equal to the two outer layers 32, but rather only one outer layer 32 (reinforcement layer 33) can be present. It would also be possible to provide three or more outer layers 32. The variation of the number of outer layers 32 can be realized in any embodiment of the electric arc blast nozzle 10, particularly in the embodiments according to FIGS. 1 to 4.

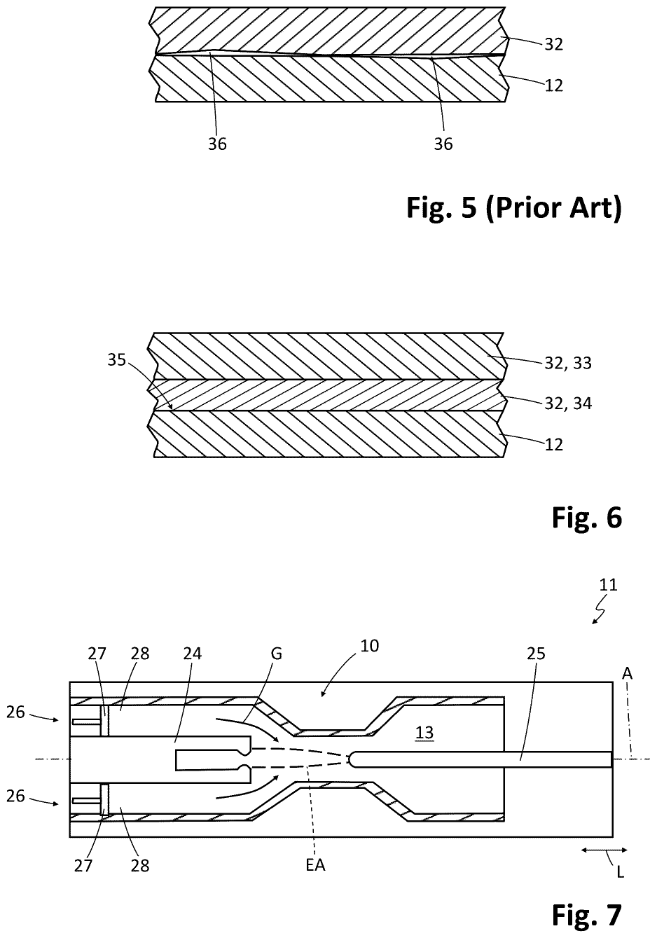

An important aspect of the present invention is a tight two-dimensional contact between the outer layer 32 directly adjoining an housing outer surface 35 of the interior housing 12, as schematically shown in FIG. 6. Similarly, a tight two-dimensional contact is created between two adjoining outer layers 32 if more than one outer layer 32 is present, as exemplarily illustrated in FIG. 6. Particularly in the connection area between the outer layer 32 that is in direct contact with the housing outer surface 35, no gas (particularly air) filled gaps or cavities 36 are created, as it is the case if adjoining parts are assembled with one another (compare prior art according to FIG. 5).

In an order to avoid creation of a gas-filled cavities 36, the outer layer 32 directly adjoining the housing outer surface 35 may be connected in substance-bond manner with the housing outer surface 35 during and due to the production of the directly adjoining outer layer 32. The directly adjoining outer layer 32 can be the insulating layer 34, as illustrated in FIG. 6 or alternatively also the reinforcement layer 33.

The at least one outer layer 32 may be produced in a molding process, for example injection molding process. For example, the outer layer 32 directly adjoining the housing outer surface 35 can be produced by a multiple component molding process and thus can be molded onto the respective surface area of the housing outer surface 12 (overmold outer layer). If more than one outer layer 32 is present, the at least one additional outer layer 32 can be produced by a molding process and can be molded onto the preceding outer layer, respectively. For example, in FIG. 6, first the innermost outer layer 32 directly adjoining the housing outer surface 35 is molded thereon and subsequently the next outer layer 32 is in turn molded on the innermost outer layer 32. This process can be similarly continued if more than two outer layers 32 are present.

Prior to overmolding the housing outer surface 35 by the directly adjoining outer layer 32, the housing outer surface 35 can be subject to a chemical, electro-chemical. physical or thermal surface treatment process, such as etching. This surface treatment process may be used to modify the chemical composition of the interior housing material at least in a volume portion including the housing outer surface 35. In this volume portion, present chemical components can be modified, reduced or eliminated. It is, for example, possible to eliminate or at least reduce the fraction of fluorine in this volume portion, for example if the interior housing 12 or the covered section 16 and/or 17 and/or 18 thereof comprises fluorine, e.g. a fluorocarbon polymer material, such as PTFE.

The thickness of the reinforcement layer 33 may be adapted to the dimension of the interior housing 12. In an embodiment, the thickness of the reinforcement layer 33 is at least 50% of the wall thickness of the interior housing at a position where the interior housing has a minimum thickness.

The invention refers to an electric arc blast nozzle 10 having an interior housing 12 extending along a longitudinal axis X and enclosing an interior space 13. The interior housing 12 is particularly configured to locate electrical contacts 24, 25 of a circuit breaker 11 therein. When used in a circuit breaker, the electric arc blast nozzle 10 can be moved together with one of the electrical contacts in longitudinal direction L relative to the other electrical contact. According to the invention, the interior housing 12 of the electric arc blast nozzle 10 is intimately covered by at least one outer layer 32 comprising a reinforcement layer 33. In doing so, gas-filled gaps and cavities are avoided between the at least one outer layer 32 and the interior housing 12, which reduces the risk of partial discharge.

### LIST OF REFERENCE SIGNS

10 electric arc blast nozzle
11 circuit breaker
12 interior housing
13 inner space
14 first axial end of interior housing
15 second axial end of interior housing
16 first nozzle end section
17 second nozzle end section
18 intermediate nozzle section
19 insert
24 first electrical contact
25 second electrical contact
26 gas flow producing device
27 piston
28 cylinder chamber
32 outer layer
33 reinforcement layer
34 insulation layer
35 housing outer surface
36 cavity
EA electrical arc
G gas flow
L longitudinal direction
X longitudinal axis

We claim:

1. An electric arc blast nozzle configured for use in a high voltage circuit breaker, wherein the electric arc blast nozzle comprises:
an interior housing extending along a longitudinal axis and having a first nozzle end section, a second nozzle end section and an intermediate nozzle section arranged between the first nozzle end section and the second nozzle end section with view in a longitudinal direction parallel to the longitudinal axis,
at least one outer layer comprising a reinforcement layer that is directly or indirectly connected with a housing outer surface of the interior housing with intimate two-dimensional contact.

2. The electric arc blast nozzle according to claim 1, wherein the at least one outer layer is attached to the housing outer surface of the interior housing by means of substance bond.

3. The electric arc blast nozzle according to claim 1, wherein the at least one outer layer is attached to the housing outer surface of the interior housing during and due to the creation of the at least one outer layer.

4. The electric arc blast nozzle according to claim 1, wherein the at least one outer layer is attached to the housing outer surface of the interior housing by means of overmolding the interior housing.

5. The electric arc blast nozzle according to claim 1, wherein at least two outer layers are provided.

6. The electric arc blast nozzle according to claim 5, wherein the at least two outer layers comprises an insulation layer for increasing the dielectric strength.

7. The electric arc blast nozzle according to claim 6, wherein the insulation layer is arranged between the interior housing and the reinforcement layer or wherein the reinforcement layer is arranged between the interior housing and the insulation layer.

8. The electric arc blast nozzle according to claim 5, wherein the at least two outer layers are attached to one another by means of substance bond.

9. The electric arc blast nozzle according to claim 5, wherein the at least two outer layers are attached to one another during and due to the creation of at least one of the outer layers.

10. The electric arc blast nozzle according to claim 5, wherein the at least two outer layers are attached to one another by means of overmolding one of the outer layers with another one of the outer layers.

11. The electric arc blast nozzle according to claim 1, wherein the reinforcement layer extends in longitudinal direction partly or entirely over the first nozzle end section, whereas the reinforcement layer does not cover at least parts of the intermediate nozzle section and does not cover the second nozzle end section.

12. The electric arc blast nozzle according to claim 11, wherein the reinforcement layer extends in longitudinal direction over the first nozzle end section and partly or entirely over the intermediate nozzle section, whereas the reinforcement layer does not cover the second nozzle end section.

13. The electric arc blast nozzle according to claim 12, wherein the reinforcement layer extends in longitudinal direction over the first nozzle end section, over the intermediate nozzle section and partly or entirely over the second nozzle end section.

14. The electric arc blast nozzle according to claim 13, wherein the reinforcement layer extends in longitudinal direction over the entire interior housing.

15. The electric arc blast nozzle according to claim 1, wherein the reinforcement layer comprises at least one of: a synthetic resin, a polymer material, a ceramic material and reinforcement fibers.

16. The electric arc blast nozzle according to claim 15, wherein the synthetic resin comprises an epoxy resin.
